(19) United States
(12) Patent Application Publication
(10) Pub. No.: US 2008/0204003 A1
(43) Pub. Date: Aug. 28, 2008

(54) Method and Device for Compensating for Temperature During a Recording of Rotation Angles with a Plunger Core

(76) Inventors: Gerhard Knecht, Iffezheim (DE); David Fricker, Kaltenhouse (FR)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/814,220

(22) PCT Filed: Feb. 6, 2006
(86) PCT No.: PCT/EP06/50684

§ 371 Date: Jul. 18, 2007

(30) Foreign Application Priority Data
Mar. 31, 2005 (DE) 10 2005 014 659.7

(51) Int. Cl. G01B 7/30

(52) U.S. Cl. 324/207.12

(57) ABSTRACT

The invention relates to a device and to a method for contactlessly recording rotation angles of a rotating element, with a plunger core and with a coil at least partially surrounding the plunger core. The plunger core and the coil move relative to one another in an axial direction according to the rotational motion of the rotating element and causes a change in a coil inductivity of the coil. The inventive device and the inventive method are characterized in that compensating means are provided, which at least partially compensate for the influence of a changing temperature upon the coil inductivity.

### PRIOR ART

The invention relates to a method and a device for contactless detection of the rotation angle of a rotatable element as generically defined by the preambles to the independent claims.

From German Patent Disclosure DE-A 100 17 061, an arrangement for in particular contactless detection of the rotation angle of a rotatable element is known, in which by evaluation of magnetically variable properties of a sensor array with at least two sensor elements, a magnetic field intensity generated or varied by the rotatable element is detectable in an evaluation circuit and used for ascertaining the rotational position; one sensor element functions by utilizing the magnetoresistive effect, and at least two further sensor elements operate by utilizing the Hall effect, and the evaluation circuit serves the purpose of logically linking the three sensor signals thus obtained.

For contactless detection of the rotation angle of a rotatable element, in addition to a magnetoresistive sensor element which outputs at least a first signal for detecting a rotation angle in a first range, it is also known to use a plunger core, disposed on a shaft of the rotatable element, as well as a coil at least partly surrounding the plunger core, and the plunger core and coil move in the axial direction relative to one another as a function of the rotary motion of the shaft, so that rotation angles that go beyond the first range can be unainbiguously detected.

From Japanese Patent Disclosure JP-A 2004226124, a rotation angle detector, comprising a ring magnet and two Hall elements, of an angle sensor is known in which, during the manufacturing phase, a detection error resulting from temperature changes and variations in mass-produced items is compensated for using measured amplitudes and offset voltages of the Hall signals.

It is also known from Japanese Patent Disclosure JP-A 2003161637 to correct the temperature of a detection coil of a device by measuring the temperature resistance of the detection coil using a resistor connected in series with the detection coil and comparing the resultant measured temperature values with temperature data stored in memory in a table.

### ADVANTAGES OF THE INVENTION

Compared to the prior art, a device and method of the invention for contactless detection of the rotation angle of a rotatable element, having a plunger core and having a coil at least partly surrounding the plunger core, the plunger core and the coil moving relative to one another in the axial direction as a function of the rotary motion of the rotatable element and causing a change in a coil inductance of the coil, have the advantage that temperature influences that cause an unintended change in the coil inductance can be compensated for during the rotation angle detection. In this way, erroneous information, which in an electric power steering drive mechanism, for instance, could lead to safety-critical situations, can be avoided effectively and economically. For that purpose, compensation means are provided, which at least partly compensate for the influence of the varying temperature on the ascertained coil inductance.

Advantageously, the compensation means include a reference coil inductance, which can be ascertained from at least one reference coil with an immovable core, and the at least one reference coil and the coil and/or the immovable coil and the plunger core should have approximately the same material properties, so that forming a ratio of the inductances maximally eliminates the influence of temperature. It is furthermore advantageous if the reference coil is located in the spatial vicinity of the coil, so that both coils will experience a comparable temperature influence.

In an alternative embodiment, the reference coil inductance of at least the region of the coil which upon axial motion predominantly or always embraces the plunger core is ascertained. As a result, there is the advantage that no additional reference coil is necessary for ascertaining the reference coil inductance, and thus both costs and installation space can be saved.

Advantageously, it is also provided that the compensation means include at least one temperature-dependent sensor element for measuring measured temperature values and at least one reference means; for compensating for the influence of the temperature on the coil inductance, the measured temperature values effected with reference temperature values stored in memory in a reference table of the at least one reference means and/or by computation using an algorithm contained in the at least one reference means. A resistor with a negative temperature coefficient (NTC) can for instance be used as the temperature-dependent sensor element.

From the prior art already discussed at the outset, it is known, in addition to the plunger core disposed on the rotatable element and to the coil at least partly surrounding the plunger core, to use a magnetoresistive sensor element for the rotation angle detection. In this connection, the magnetoresistive sensor element may especially advantageously serve as a compensation means, in that the absolute amplitudes and/or offset voltages of the plurality of sensor signals output by the magnetoresistive sensor element are measured prior to a standardization operation and/or formation of a ratio between the sensor signals.

Further advantages of the invention will become apparent from the characteristics recited in the dependent claims and from the drawings and the ensuing description.

### DRAWINGS

The invention is described below in terms of examples in conj unction with FIGS. 1 through 5, in which the same reference numerals refer to the same components having the same mode of operation. Shown are

FIG. 1: a schematic illustration of a device for contactless detection of the rotation angle of a rotatable element in the prior art;

FIG. 2: a schematic illustration of a first exemplary embodiment of the device of the invention;

FIG. 3: a schematic illustration of a second and third exemplary embodiment of the device of the invention;

FIG. 4: a schematic illustration of a fourth exemplary embodiment of the device of the invention; and

FIG. 5: a graph of the sensor signals, output by a magnetoresistive sensor element, prior to standardization as a function of the rotation angle of the rotatable element.

### DESCRIPTION

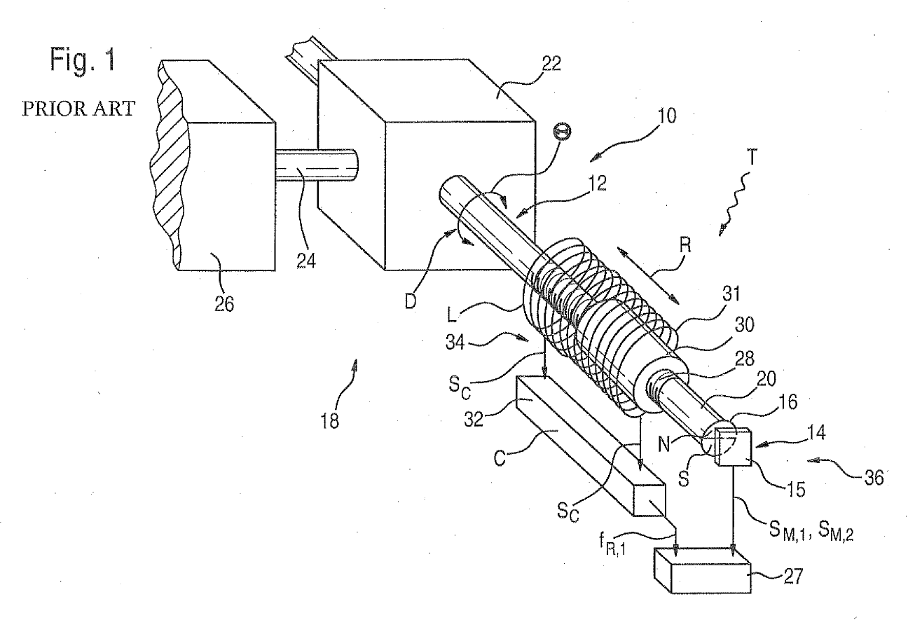

In FIG. 1, a schematic illustration is shown of a device 10 of the prior art for contactless detection of the rotation angle of a rotatable element 12, having a magnetoresistive sensor element 14 which outputs two signals S_{M,1} and S_{M, 2} for detecting a rotation angle Θ of the rotatable element 12. For triggering the magnetoresistive sensor element 14, which in this case is embodied as an anisotropic, magnetoresistive (AMR) sensor 15, a permanent magnet 16 is used that has a north pole N and a south pole S. Instead of a permanent magnet 16 with only two alternating poles (pair of poles), it is naturally equally possible to use permanent magnets with markedly more pairs of poles. It is equally possible, instead of the AMR sensor 15, to use other magnetoresistive sensor elements. Below, however, for the sake of simplicity, an AMR sensor 15 will be assumed.

The rotatable element 12 is embodied as an electrical power steering drive mechanism 18, in which a shaft 20 which is connected to an electric motor 26 via a drive unit 22, for instance a step-down gear not further described here, and a drive shaft 24.

The shaft 20 is a component of the rotatable element 12. By means of the AMR sensor 15 and the permanent magnet 16 associated with it, rotation angles Θ in a first range D from 0° to 180° can be detected exactly and unambiguously. The AMR sensor 15 outputs the sensor signals S_{M,1} and S_{M,2}, which have a sinusoidal and cosinusoidal course as a function of the rotation angle Θ, and forwards them to an evaluation circuit 27. The signals S_{M,1} and S_{M,2} have a periodicity of 180°, so that rotation angles Θ of more than 180+ can no longer be detected unambiguously using only a single AMR sensor. For unambiguous determination of rotation angles Θ outside this first range D, or in other words of more than 180+, a further device is accordingly necessary. To that end, on the shaft 20 a thread 28 is provided, with which, as a function of the rotary motion of the shaft 20, a plunger core 30, which may have a corresponding thread, not shown, or mandrel, also not shown, moves relative to a coil 31 in the axial direction R of the shaft 20. The plunger core 30 may for instance comprise a ferromagnetic material, such as iron, neodymium, AlNiCo (an aluninum-nickel-cobalt alloy), or the like.

If the shaft 20 now rotates by a certain amount, then the plunger core 30, because of the thread 28, moves in the axial direction R inside the coil 31 and causes a change in its coil inductance L. This change is sent by means of a coil signal S_{c} to a capacitor 32 hawing the capacitance C, and this capacitor together with the coil inductance L forms a first oscillating circuit 34 with the resonant frequency f_{R,1}; the varying coil inductance L also causes a change in the resonant frequency f_{R,1}. Instead of a single capacitor 32 of capacitance C, naturally individual components or a plurality of different components may be provided that in combination with the coil inductance L bring about a characteristic resonant frequency f_{R,1} of the resultant first serial and/or parallel oscillating circuit. However, the assumption hereinafter will always be an LC oscillating circuit 34.

From the influence of a varying temperature T, for instance because of the radiated heat of an internal combustion engine installed in a motor vehicle, or sunshine, or the like, a change can occur in the coil inductance L of the coil 31. According to the invention, compensation means 36 are therefore provided, which at least partly compensate for the influence of the varying temperature T on the coil inductance L.

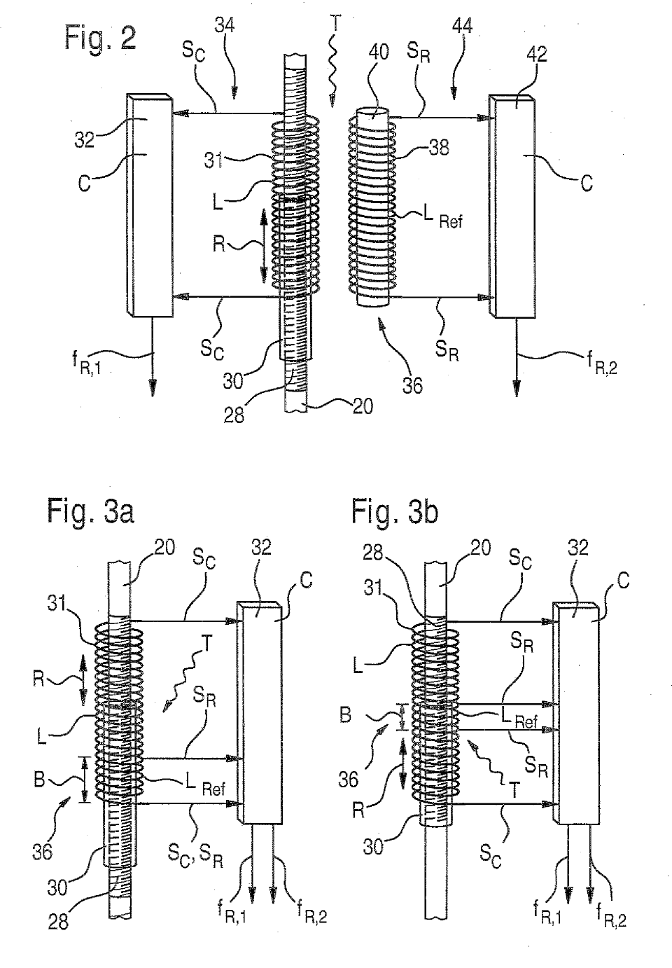

In a first exemplary embodiment, shown in FIG. 2, the compensation means 36 include a reference coil inductance L_{Ref}, which results from a reference coil 38 with an immovable core 40. The reference coil 38 and/or the immovable core 40 have approximately the same—and ideally identical—material properties as the coil 31 and the plunger core 30. Moreover, the reference coil 38 and the coil 31 are disposed in the vicinity of one another spatially, so that any influence of the temperature T acts in the same way on both coils. In accordance with the description of FIG. 1, the reference coil 38 outputs a reference coil signal S_{R} to a further capacitor 42, which should if at all possible have the same capacitance C as the capacitor 32 of the first oscillating circuit 34. The reference coil inductance L_{Ref} and the capacitance C form a reference oscillating circuit 44 having a reference resonant frequency f_{R,2}. By forming a ratio between the resonant frequency f_{R,1} of the first oscillating circuit 34 and the reference resonant frequency f_{R,2} of the reference oscillating circuit 44, the influence of the temperature T on the coil inductance L of the coil 31 can now be compensated for. If the two capacitors 32 and 42 have different capacitances, then they must be taken into account in forming the ratio of the reference resonant frequencies, to prevent the outcome from being wrong.

In FIG. 3, two further exemplary embodiments of the device 10 of the invention are shown. Instead of an additional reference coil, however, the compensation means 36 now include that region B of the coil 31 which, to ascertain the reference coil inductance L_{Ref}, predominantly or always embraces the plunger core 30 upon an axial motion in the direction R.

In FIG. 3a, the coil 31 and the thread 28 located on the shaft 20 are embodied in such a way that the plunger core 30 cannot leave the region B of the coil 31 upon a rotary motion of the shaft 20. In the region B of the coil 31, the same conditions therefore always prevail, conditions which are changed only by the influence of the temperature T but not by the relative motion between the coil 31 and the plunger core 30. All that is accordingly necessary is for the coil 31 to be tapped at both ends of the region B; one end of the region B is already defined by the end of the coil 31, and hence only one additional tap is needed in order to ascertain the reference coil inductance L_{Ref}. The resultant reference coil signal S_{R} is then forwarded, in a corresponding way to the coil signal S_{c} of the coil 31, to the capacitor 32 of capacitance C for determining the reference resonant frequency f_{R,2} as described in conjunction with FIG. 2. From the ratio between the reference resonant frequency f_{R,2} and the likewise-ascertained resonant frequency f_{R,1} of the coil 31, it is then possible in turn to compensate for the influence of the temperature T on the coil inductance L of the coil 31.

The exemplary embodiment in FIG. 3b differs from that in FIG. 3a only in a modified embodiment of the plunger core 30 and the thread 28, so that now the region B of the coil 31 which predominantly or always embraces the plunger core 30 upon the axial motion of the plunger core is located in the middle of the coil 31. In this way, although two additional taps of the coil 31 are necessary, by way of which the reference coil signal S_{R} of the reference coil inductance L_{Ref} is sent to the capacitor 32, nevertheless this arrangement makes a lesser structural length of the shaft 20 of the rotatable element 12 possible, compared to FIG. 3a.

In FIG. 3, it is understood that instead of one common capacitor 32, a plurality of capacitors—as already described in conjunction with FIG. 2—may be used; advantageously, however, it is not absolutely necessary for the capacitors to have the same capacitance C. Moreover, there is an alternative of ascertaining the coil inductance from measuring the times or amplitudes for a step response.

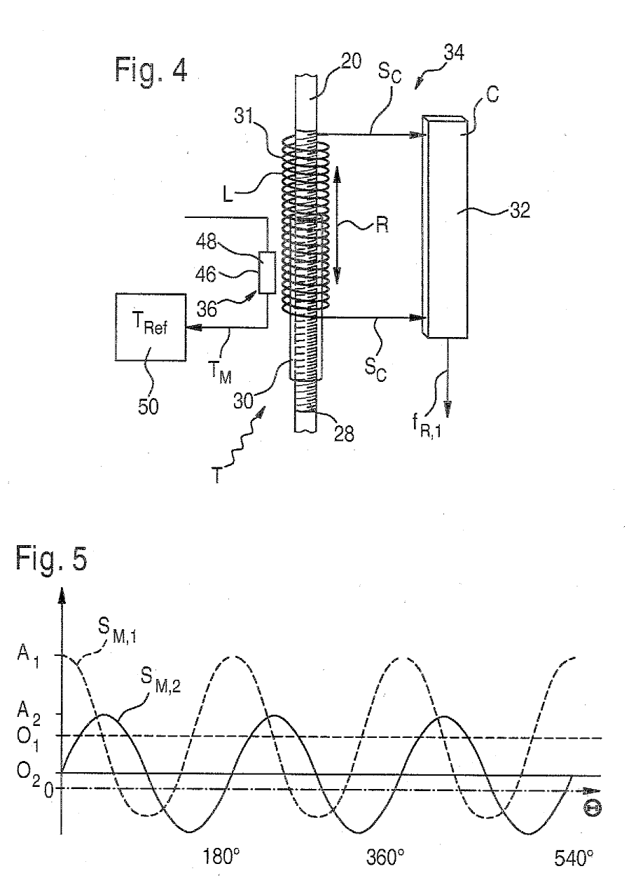

A further exemplary embodiment for compensating for the influence of the temperature T on the coil inductance L of the coil 31 is shown in FIG. 4; the compensation means 36 now include a temperature-sensitive sensor element 46, such as a resistor with a negative temperature coefficient (NTC) 48. Instead of an NTC 48, however, still other temperature-sensitive sensor elements may be used, such as a PTC or the like. To compensate for the influence of temperature, the temperature T is measured by the NTC 48, and a comparison is made of the measured temperature values T with reference temperature values T_{Ref} stored in memory in a reference table of a reference means 50, in such a way that each reference temperature value T_{Ref} is allocated a certain reference resonant frequency f_{R,2}, which is put in ratio with the first resonant frequency f_{R,1} ascertained by means of the first oscillating circuit 34.

Instead of a reference table, it is naturally equally possible to compensate for the influence of temperature computationally with the aid of a suitable algorithm in the reference means 50. In this way, higher accuracy can be attained, since the reference temperature values T_{Ref} stored in memory in the reference table originated in only a finite supply of values. As the reference means 50, a microprocessor, ASIC, or other integrated circuit, for instance, which preferably has a comparator and a memory, may be used. It is understood that still other reference means 50 may be used, for instance if a discrete construction with separate groups of components for the arithmetic unit, the comparator and/or the memory is preferred.

In FIG. 5, it is provided that the compensation means 36 include the additional AMR sensor 15 shown in FIG. 1. It outputs the sinusoidal and cosinusoidal sensor signals S_{M,1} and S_{M,2}, which are plotted in the graph shown in FIG. 5 as a function of the rotation angle Θ before their standardization. The AMR sensor 15, like the coil 31, is thus subject to the influence of the temperature T. Therefore the two sensor signals S_{M,1} and S_{M,2} are also temperature-dependent, which can cause a change in their absolute amplitudes A₁ and A₂ and/or their offset voltages O₁ and O₂, which must be measured before a standardization operation and/or formation of a ratio between the sensor signals S_{M,1} and S_{M,2}. Since both sensor signals S_{M,1} and S_{M,2} react in the same way to the influence of temperature, it suffices to use only one of the two absolute amplitudes A₁ or A₂ and/or offset voltages O₁ or O₂ for the compensation of the temperature influence. It is understood that the measured values of both sensor signals may also be used. The compensation is now done again with the aid of reference values, stored in memory in a reference table, for the amplitudes and/or offset voltages and the reference resonant frequencies f_{R,2} that can be derived from them, or by computation using an algorithm.

It closing, it should also be pointed out that the exemplary embodiments shown are not limited to FIGS. 2 through 5. For instance, a plurality of compensation means 36 may be combined, or a plurality of reference coils or coil taps may be used as compensation means. It is moreover conceivable for the reference coil 40 to be disposed not parallel but at an arbitrary angle to the coil 31, depending on the spatial requirements.

1-18. (canceled)

19. A device for contactless detection of the rotation angle of a rotatable element, the device compressing a plunger core, a coil at least partly surrounding the plunger core, the plunger core and the coil being movable relative to one another in the axial direction as a function of the rotary motion of the rotatable element and causing a change in a coil inductance of the coil, and compensation means which at least partly compensate for the influence of a varying temperature on the coil inductance.

20. The device as defined by claim 19, wherein the compensation means comprises a reference coil inductance.

21. The device as defined by claim 20, wherein the reference coil inductance results from at least one reference coil having an immovable core.

22. The device as defined by claim 21, wherein the at least one reference coil and the coil have approximately the same material properties.

23. The device as defined by claim 21, wherein the immovable core and the plunger core have approximately the same material properties.

24. The device as defined by claim 21, wherein the reference coil and the coil are disposed in the vicinity of one another spatially.

25. The device as defined by claim 20, wherein the reference coil inductance results from at least the region of the coil which predominantly or always embraces the plunger core upon axial motion.

26. The device as defined by claim 19, wherein the compensation means comprises at least one temperature-dependent sensor element for measuring measured temperature values and at least one reference means.

27. The device as defined by claim 26, wherein for compensating for the influence of the temperature on the coil inductance, the measured temperature values are compared with reference temperature values stored in memory in a reference table of the at least one reference means and/or by computation using an algorithm contained in the at least one reference means.

28. The device as defined by claim 26, wherein the temperature-dependent sensor element is an NTC.

29. The device as defined by claim 27, wherein the temperature-dependent sensor element is an NTC.

30. The device as defined by claim 19, further comprising at least one additional, magnetoresistive sensor element for detecting the rotation angles.

31. The device as defined by claim 30, wherein the compensation means comprises the at least one additional, magnetoresistive sensor element.

32. A method for contactless detection of the rotation angle of a rotatable element, having a plunger core and having a coil at least partly surrounding the plunger core, the plunger core and the coil moving relative to one another in the axial direction as a function of the rotary motion of the rotatable element and a resultant coil inductance of the coil is ascertained, the method comprising employing compensation means partly compensating for the influence of a varying temperature on the coil inductance.

33. The method as defined by claim 32, further comprising the step of ascertaining a reference coil inductance of the compensation means.

34. The method as defined by claim 33, further comprising the step of ascertaining the reference coil inductance of at least one reference coil with an immovable core

35. The method as defined by claim 33, further comprising the step of ascertaining the reference coil inductance of at least the region of the coil which upon axial motion predominantly or always embraces the plunger core.

36. The method as defined by claim 32, further comprising the steps of measuring the temperature with at least one temperature-dependent sensor element of the compensation means, and comparing the measured temperature values with reference temperature values stored in memory in a reference table of at least one reference means, and/or compensating for the influence of the temperature by means of the measured temperature values measured with the temperature-dependent sensor element, by computation with the aid of an algorithm contained in the at least one reference means.

37. The method as defined by claim 32, further compressing outputting a plurality of sensor signals by at least one additional, magnetoresistive sensor element of the compensation means, and measuring the absolute amplitudes and/or offset voltages of the sensor signals before a standardization operation and/or formation of a ratio between the sensor signals.
